(19) United States
(12) Patent Application Publication
(10) Pub. No.: US 2025/0239068 A1
(43) Pub. Date: Jul. 24, 2025

(54) VIDEO PROCESSING SYSTEM, VIDEO PROCESSING METHOD, AND VIDEO PROCESSING APPARATUS

(71) Applicant: NEC Corporation, Minato-ku, Tokyo (JP)

(72) Inventors: Yasunori BABAZAKI, Tokyo (JP); Katsuhiko TAKAHASHI, Tokyo (JP); Jun PIAO, Tokyo (JP); Ryuhei ANDO, Tokyo (JP); Takanori IWAI, Tokyo (JP); Koichi NIHEI, Tokyo (JP); Florian BEYE, Tokyo (JP); Hayato ITSUMI, Tokyo (JP)

(73) Assignee: NEC Corporation, Minato-ku, Tokyo (JP)

(21) Appl. No.: 18/855,465

(22) PCT Filed: Aug. 31, 2022
(86) PCT No.: PCT/JP2022/032761

§ 371 Date: Oct. 9, 2024

(51) Int. Cl. G06V 10/98; G06T 7/73; G06V 10/62; G06V 10/77; G06V 20/40; G06V 40/20

(52) U.S. Cl. CPC G06V 10/98; G06T 7/74; G06V 10/62; G06V 10/7715; G06V 20/41; G06V 40/20; G06T 2207/10016; G06T 2207/30196

(57) ABSTRACT

A video processing system (10) includes an image quality control unit (11) that controls an image quality of a gaze region including a gaze target in an input video, a recognition unit (12) that performs recognition processing of recognizing the gaze target on the video in which the image quality of the gaze region is controlled, a prediction unit (13) that predicts a position of the gaze target in a video subsequent to the video on which the recognition processing has been performed, based on extraction information extracted from the recognition processing, and a determination unit (14) that determines the gaze region for which the image quality control means (11) controls an image quality in the subsequent video, based on the predicted position of the gaze target.

### TECHNICAL FIELD

The present disclosure relates to a video processing system, a video processing method, and a video processing apparatus.

### BACKGROUND ART

A system that performs monitoring and the like by applying a detection technique and a recognition technique using machine learning to a video captured by a camera is being developed.

Patent Literature 1 is known as related techniques. Patent Literature 1 discloses a technique of assigning a band to each camera in accordance with an available band of a network and the importance of a target object detected by each camera in a remote monitoring system that transmits videos captured by a plurality of cameras mounted on a vehicle via the network. In addition, Patent Literature 1 also discloses that a position of a target object is predicted to acquire a region where the object may be present.

### CITATION LIST

### Patent Literature

Patent Literature 1: International Patent Publication No. WO2021/070214

### SUMMARY OF INVENTION

### Technical Problem

In Patent Literature 1, it is possible to appropriately control a band for transmitting a video in accordance with the importance of an object detected from the video. On the other hand, in a system that performs recognition processing such as action recognition on a video, it is desirable to improve recognition accuracy.

In view of such a problem, an object of the present disclosure is to provide a video processing system, a video processing method, and a video processing apparatus capable of improving recognition accuracy.

### Solution to Problem

According to the present disclosure, a video processing system includes image quality control means for controlling an image quality of a gaze region including a gaze target in an input video, recognition means for performing recognition processing of recognizing the gaze target on the video in which the image quality of the gaze region is controlled, prediction means for predicting a position of the gaze target in a video subsequent to the video on which the recognition processing has been performed, based on extraction information extracted from the recognition processing, and determination means for determining the gaze region for which the image quality control means controls an image quality in the subsequent video, based on the predicted position of the gaze target.

According to the present disclosure, a video processing method includes controlling an image quality of a gaze region including a gaze target in an input video, performing recognition processing of recognizing the gaze target on a video in which the image quality of the gaze region is controlled, predicting a position of the gaze target in a video subsequent to the video on which the recognition processing has been performed, based on extraction information extracted from the recognition processing, and determining the gaze region for which an image quality is controlled in the subsequent video, based on the predicted position of the gaze target.

According to the present disclosure, a video processing apparatus includes image quality control means for controlling an image quality of a gaze region including a gaze target in an input video, recognition means for performing recognition processing of recognizing the gaze target on the video in which the image quality of the gaze region is controlled, prediction means for predicting a position of the gaze target in a video subsequent to the video on which the recognition processing has been performed, based on extraction information extracted from the recognition processing, and determination means for determining the gaze region for which the image quality control means controls an image quality in the subsequent video, based on the predicted position of the gaze target.

### Advantageous Effects of Invention

According to the present disclosure, it is possible to provide a video processing system, a video processing method, and a video processing apparatus capable of improving recognition accuracy.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to the example embodiment.

FIG. 3 is a flowchart illustrating an outline of a video processing method according to the example embodiment.

FIG. 4 is a configuration diagram illustrating a basic configuration of a remote monitoring system.

FIG. 5 is a configuration diagram illustrating a configuration example of a terminal according to a first example embodiment.

FIG. 6 is a configuration diagram illustrating a configuration example of a center server according to the first example embodiment.

FIG. 7 is a configuration diagram illustrating a configuration example of an action recognition unit according to the first example embodiment.

FIG. 8 is a configuration diagram illustrating another configuration example of the action recognition unit according to the first example embodiment.

FIG. 9 is a flowchart illustrating an operation example of the remote monitoring system according to the first example embodiment.

FIG. 10 is a diagram for describing video acquisition processing according to the first example embodiment.

FIG. 11 is a diagram for describing object detection processing according to the first example embodiment.

FIG. 12 is a flowchart illustrating an operation example of action recognition processing according to the first example embodiment.

FIG. 13 is a diagram for describing the action recognition processing according to the first example embodiment.

FIG. 14 is a diagram for describing the action recognition processing according to the first example embodiment.

FIG. 15 is a flowchart illustrating another operation example of the action recognition processing according to the first example embodiment.

FIG. 16 is a diagram for describing the action recognition processing according to the first example embodiment.

FIG. 17 is a diagram for describing gaze target position prediction processing according to the first example embodiment.

FIG. 18 is a diagram for describing the gaze target position prediction processing according to the first example embodiment.

FIG. 19 is a diagram for describing the gaze target position prediction processing according to the first example embodiment.

FIG. 20 is a diagram for describing gaze region determination processing according to the first example embodiment.

FIG. 21 is a configuration diagram illustrating a configuration example of a terminal according to a second example embodiment.

FIG. 22 is a flowchart illustrating an operation example of a remote monitoring system according to the second example embodiment.

FIG. 23 is a flowchart illustrating an operation example of matching determination processing according to the second example embodiment.

FIG. 24 is a diagram for describing the matching determination processing according to the second example embodiment.

FIG. 25 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

In a system that collects a video via a network and recognizes an object, an action, or the like in the video, it is preferable to suppress the data amount of the video to be transmitted as much as possible because the band of the network that transmits the video is limited. For example, the data amount of the video can be suppressed by increasing the compression rate of the video. However, in a case where the video compression rate is high or in a case where the data loss rate is high, erroneous recognition increases, and thus the recognition accuracy decreases. Therefore, in the example embodiments, it is possible to prevent the erroneous recognition while suppressing the data amount of a video to be transmitted as much as possible.

### Outline of Example Embodiment

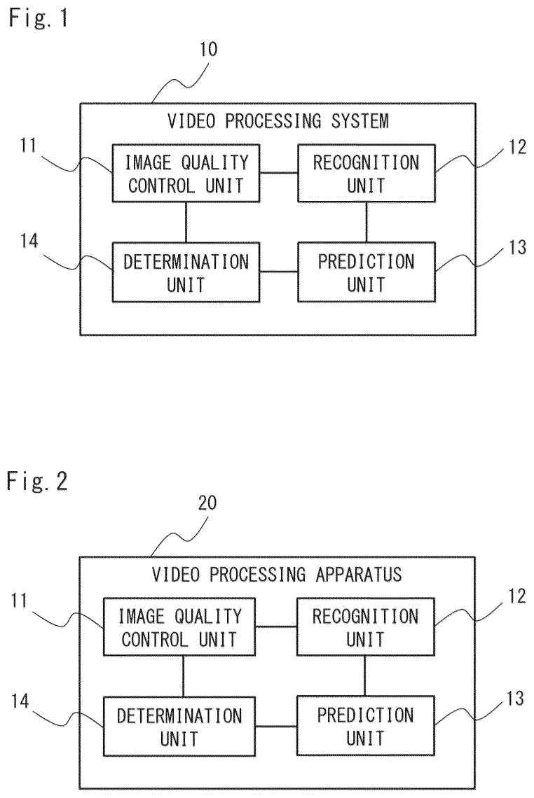

First, an outline of an example embodiment will be described. FIG. 1 illustrates a configuration outline of a video processing system 10 according to the example embodiment. The video processing system 10 can be applied to, for example, a remote monitoring system that collects videos via a network and monitors the videos.

As illustrated in FIG. 1, the video processing system 10 includes an image quality control unit 11, a recognition unit 12, a prediction unit 13, and a determination unit 14.

The image quality control unit 11 controls the image quality of a gaze region including a gaze target in the input video. For example, the image quality control unit 11 may make the image quality of the gaze region higher, that is, sharper than other regions. The recognition unit 12 performs recognition processing of recognizing a gaze target on the video in which the image quality of the gaze region is controlled by the image quality control unit 11. The recognition processing is, for example, action recognition processing of recognizing an action of a gaze target, and may be processing of recognizing information, features, and the like regarding other gaze targets.

The prediction unit 13 predicts the position of a gaze target in a video subsequent to the video on which the recognition processing has been performed, based on extraction information extracted from the recognition processing performed by the recognition unit 12, the extraction information being information extracted regarding the gaze target. The extraction information is information regarding an extraction target extracted from a video by the video processing system 10. For example, the extraction information may include time-series position information of a gaze target, or may include an action recognition result that is an example of a recognition result in recognition processing. The determination unit 14 determines a gaze region where the image quality control unit 11 controls the image quality in the subsequent video, based on the position of the gaze target predicted by the prediction unit 13. The image quality control unit 11 controls the image quality of the gaze region determined by the determination unit 14 with respect to the input video. For example, the image quality control unit 11 first controls the image quality in accordance with a predetermined rule (for example, sharpening all the regions, and the like), and then controls the image quality of the determined gaze region after the prediction of the gaze target by the prediction unit 13 and the determination of the gaze region by the determination unit 14.

Note that the video processing system 10 may be configured by one apparatus or a plurality of apparatuses. FIG. 2 illustrates a configuration of a video processing apparatus 20 according to the example embodiment. As illustrated in FIG. 2, the video processing apparatus 20 may include the image quality control unit 11, the recognition unit 12, the prediction unit 13, and the determination unit 14 illustrated in FIG. 1. A part or the entirety of the video processing system 10 may be disposed on an edge or a cloud. For example, in a system that monitors a video captured in a site via a network, an edge is an apparatus disposed at the site or near the site, and is an apparatus close to a terminal in a hierarchy of the network. For example, the image quality control unit 11 and the determination unit 14 may be disposed in an edge terminal, and the recognition unit 12 and the prediction unit 13 may be disposed in a cloud server. Further, the functions may be distributed in the cloud.

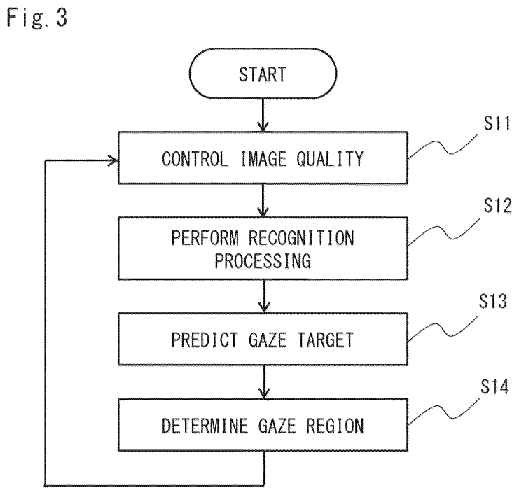

FIG. 3 illustrates a video processing method according to the example embodiment. For example, the video processing method according to the example embodiment is performed by the video processing system 10 in FIG. 1 or the video processing apparatus 20 in FIG. 2. As illustrated in FIG. 3, first, the image quality of a gaze region including a gaze target in the input video is controlled (S11). Then, recognition processing of recognizing a gaze target is performed on the video in which the image quality of the gaze region is controlled (S12). Then, the position of the gaze target in a video subsequent to the video on which the recognition processing has been performed is predicted based on the extraction information extracted from the recognition processing (S13). Then, a gaze region where the image quality control unit 11 controls the image quality in the subsequent video is determined based on the predicted position of the gaze target (S14). Further, the processing returns to S11, and the image quality of the determined gaze region is controlled on the input video.

As described above, the video processing system according to the example embodiment predicts the position of the gaze target in the subsequent video based on the extraction information extracted from the recognition processing performed on the video, and determines the gaze region in which the image quality is controlled in the subsequent video from the prediction result. As a result, it is possible to appropriately determine a region for controlling the image quality, and thus, it is possible to prevent erroneous recognition while suppressing the data amount of a video, and to improve the recognition accuracy.

### Basic Configuration of Remote Monitoring System

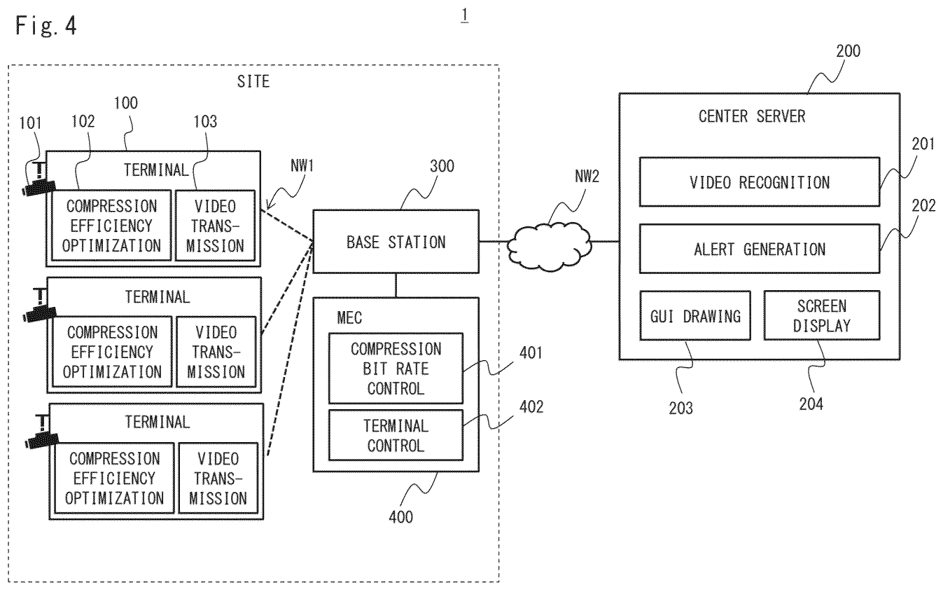

Next, the remote monitoring system that is an example of a system to which the example embodiment is applied will be described. FIG. 4 illustrates a basic configuration of a remote monitoring system 1. The remote monitoring system 1 is a system that monitors a captured area by a video captured by a camera. The present example embodiment will be described below as a system that remotely monitors work of a worker in a site. For example, the site may be an area where people and machines operate, such as a work site, for example, a construction site, a square where people gather, or a school. In the present example embodiment, the work will be described below as construction work, civil engineering work, or the like, but the work is not limited thereto. Note that the video includes a plurality of time-series images (also referred to as frames), and thus the terms video and image can be used interchangeably. That is, the remote monitoring system can be said to be a video processing system that processes a video or an image processing system that processes an image.

As illustrated in FIG. 4, the remote monitoring system 1 includes a plurality of terminals 100, a center server 200, a base station 300, and a MEC 400. The terminal 100, the base station 300, and the MEC 400 are disposed on the site side, and the center server 200 is disposed on the center side. For example, the center server 200 is disposed in a data center, a monitoring center, or the like disposed at a position away from the site. The site side is the edge side of the system, and the center side is also the cloud side. Note that the center server 200 may be configured by one apparatus or a plurality of apparatuses. Further, a part or the entirety of the center server 200 may be disposed in a cloud. For example, a video recognition function 201 and an alert generation function 202 may be disposed in the cloud, and a GUI drawing function 203 and a screen display function 204 may be disposed in a monitoring center or the like.

The terminal 100 and the base station 300 are communicatively connected by a network NW1. The network NW1 is, for example, a radio network such as 4G, local 5G/5G, long term evolution (LTE), or radio LAN. The base station 300 and the center server 200 are communicatively connected by a network NW2. The network NW2 includes, for example, a core network such as a 5th Generation Core network (5GC) or an Evolved Packet Core (EPC), the Internet, and the like. It can also be said that the terminal 100 and the center server 200 are communicatively connected via the base station 300. The base station 300 and the MEC 400 are communicatively connected by any communication method, and the base station 300 and the MEC 400 may be one apparatus.

The terminal 100 is a terminal apparatus connected to the network NW1, and is also a video generation apparatus that generates a video of the site. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency and a video transmission function 103. The compression efficiency optimization function 102 performs ROI (region of interest: also referred to as a gaze region) control for controlling the image quality of an ROI. The compression efficiency optimization function 102 reduces the bit rate by reducing the image quality of a region around the ROI including a person or an object, while maintaining the image quality of the ROI. The video transmission function 103 transmits a video having the controlled image quality to the center server 200.

The base station 300 is a base station apparatus for the network NW1, and is also a relay apparatus that relays communication between the terminal 100 and the center server 200. For example, the base station 300 is a local 5G base station, a 5G next generation node B (gNB), an LTE evolved node B (eNB), an access point of a radio LAN, or the like, but may be another relay apparatus.

The multi-access edge computing (MEC) 400 is an edge processing apparatus disposed on the edge side of the system. The MEC 400 is an edge server that controls the terminal 100, and has a compression bit rate control function 401 for controlling the bit rate of the terminal, and a terminal control function 402. The compression bit rate control function 401 controls the bit rate of the terminal 100 by adaptive video distribution control or quality of experience (QoE) control. For example, the compression bit rate control function 401 predicts the recognition accuracy to be obtained while suppressing the bit rate in accordance with the communication environment of the networks NW1 and NW2, and assigns the bit rate to the camera 101 of each terminal 100 to improve the recognition accuracy. The terminal control function 402 controls the terminal 100 to transmit the video having the assigned bit rate. The terminal 100 encodes the video to have the assigned bit rate, and transmits the encoded video.

The center server 200 is a server installed on the center side of the system. The center server 200 may be one or a plurality of physical servers, a cloud server constructed on a cloud, or other virtualization servers. The center server 200 is a monitoring apparatus that monitors work in a site by recognizing the work of a person from a camera video of the site. The center server 200 is also a recognition apparatus that recognizes an action or the like of a person in a video transmitted from the terminal 100.

The center server 200 has the video recognition function 201, the alert generation function 202, the GUI drawing function 203, and the screen display function 204. The video recognition function 201 inputs a video transmitted from the terminal 100 to a video recognition artificial intelligence (AI) engine, thereby recognizing the work performed by a worker, that is, the type of action of the person. The alert generation function 202 generates an alert in accordance with the recognized work. The GUI drawing function 203 displays a graphical user interface (GUI) on a screen of a display apparatus. The screen display function 204 displays a video, a recognition result, an alert, and the like of the terminal 100 on the GUI.

### First Example Embodiment

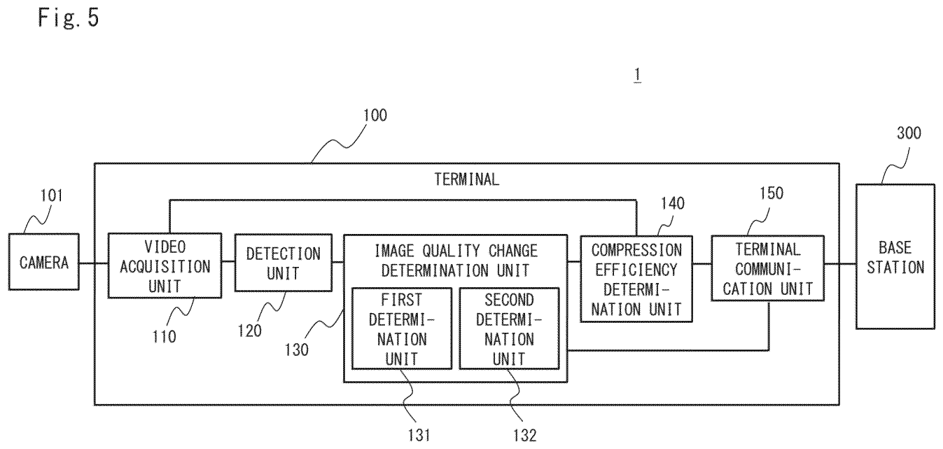

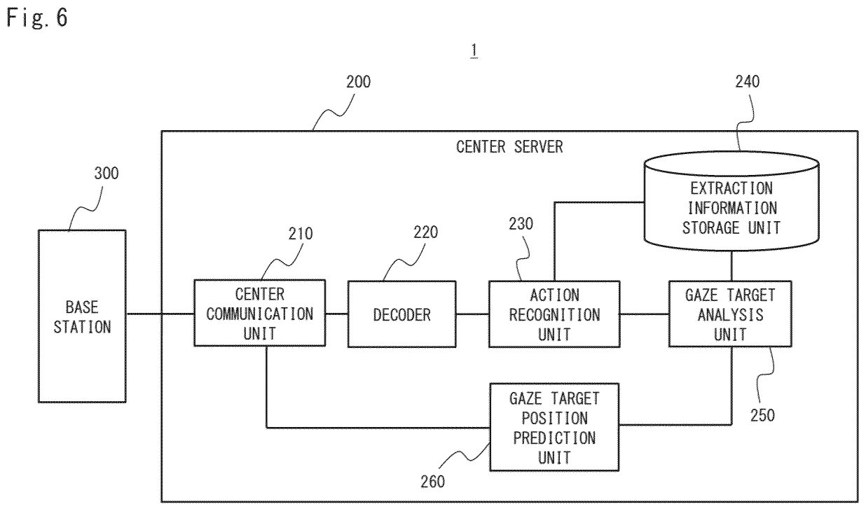

A first example embodiment will be described below with reference to the drawings. First, a configuration of a remote monitoring system according to the present example embodiment will be described. A basic configuration of the remote monitoring system 1 according to the present example embodiment is as illustrated in FIG. 4. Here, a configuration example of the terminal 100 and the center server 200 will be described. FIG. 5 illustrates a configuration example of the terminal 100 according to the present example embodiment, and FIG. 6 illustrates a configuration example of the center server 200 according to the present example embodiment. Note that the configuration of each apparatus is an example, and another configuration may be used as long as the operation to be described layer according to the present example embodiment can be performed. For example, some functions of the terminal 100 may be disposed in the center server 200 or another apparatus, or some functions of the center server 200 may be disposed in the terminal 100 or another apparatus.

As illustrated in FIG. 5, the terminal 100 includes a video acquisition unit 110, a detection unit 120, an image quality change determination unit 130, a compression efficiency determination unit 140, and a terminal communication unit 150.

The video acquisition unit 110 acquires a video (also referred to as an input video) captured by the camera 101. For example, the input video includes a person who is a worker who performs work on site, a work object (also referred to as a use object) used by the person, and the like. The video acquisition unit 110 is also an image acquisition unit that acquires a plurality of time-series images.

The detection unit 120 is an object detection unit that detects an object in the acquired input video. The detection unit 120 detects an object in each image included in the input video, and gives a label of the detected object, that is, an object label. The object label is a class of an object and indicates a type of the object. The detection unit 120 extracts a rectangular region including an object from each image included in the input video, recognizes the object in the extracted rectangular region, and gives a label of the recognized object. The rectangular region is a bounding box or an object region. Note that the object region including the object is not limited to the rectangular region, and may be a region having a circular or amorphous silhouette, or the like. The detection unit 120 calculates a feature amount of an image of the object included in the rectangular region, and recognizes the object based on the calculated feature amount. For example, the detection unit 120 recognizes the object in the image by an object recognition engine using machine learning such as deep learning. The object can be recognized by performing machine learning on the feature of the image of the object and the object label. The detection result of the object includes the object label, position information of the rectangular region including the object, and the like. The position information of the object is, for example, coordinates of each vertex of the rectangular region, and may be a position of the center of the rectangular region or a position of a certain point of the object. The detection unit 120 transmits the detection result of the object to the image quality change determination unit 130.

The image quality change determination unit 130 determines a gaze region (ROI) that is an image quality change region for changing the image quality of the acquired input video. The image quality change determination unit 130 is a determination unit that determines the gaze region. The gaze region is a region including a gaze target, and is a region for improving image quality, that is, improving sharpness. In addition, it can be said that the gaze region is a region that secures the image quality for action recognition.

For example, the image quality change determination unit 130 includes a first determination unit 131 and a second determination unit 132. For example, first, the first determination unit 131 determines a gaze region, and after the center server 200 recognizes an action, the second determination unit 132 determines the gaze region. Note that determination of the gaze region by the first determination unit 131 may be omitted, and only determination of the gaze region by the second determination unit 132 may be performed. The first determination unit 131 determines the gaze region of the input video based on the detection result of the object detected in the input video. The first determination unit 131 determines the gaze region based on the position information of the object having the label, which is a gaze target among detection objects detected in the input video by the detection unit 120. The gaze target is a person who is a target of action recognition, and may include a work object that may be used by the person in work. For example, the label of the work object is set in advance as a label of an object related to a person.

In a case where information is fed back from the center server 200 that has recognized the action, the second determination unit 132 determines the gaze region of the input video based on the fed-back information. In this example, the fed-back information is prediction information of the gaze target. The prediction information of the gaze target is information regarding the gaze target, and is information obtained by predicting the gaze target in the next video by the center server 200 performing action recognition. The prediction information of the gaze target is information extracted from the predicted position of the gaze target and action recognition processing, and includes position information of the rectangular region of the gaze target. For example, the second determination unit 132 determines the rectangular region indicated by the acquired prediction information as the gaze region. That is, the region that secures the image quality of the input video is determined based on the predicted position of the gaze target.

Furthermore, the prediction information acquired from the center server 200 may include a score of an action label that is an action recognition result. The second determination unit 132 may acquire the score of the action label that is the action recognition result from the center server 200, and determine whether or not to determine the gaze region based on the acquired score. The score of the action label indicates a certainty factor that is the certainty (probability) of the action label. The higher the score, the higher the possibility that the predicted action of the action label is correct. For example, in a case where the score is smaller than a predetermined value, the image quality of a region in which recognition is not possible is secured, and it is determined that it is necessary to further perform action recognition, and the gaze region is determined based on the prediction information. In a case where the score is larger than the predetermined value, it may be determined that it is not necessary to further perform action recognition for the recognized region, and the gaze region does not need to be determined. Conversely, in a case where the score is larger than the predetermined value, it may be determined that it is necessary to further perform action recognition for the recognized region, and the gaze region may be determined based on the prediction information. In a case where the score is smaller than the predetermined value, it may be determined that it is not necessary to further perform action recognition for the region in which recognition is not possible, and the gaze region does not need to be determined. In a case where the gaze region is not determined, the compression efficiency determination unit 140 does not need to improve the image quality of the gaze region.

The compression efficiency determination unit 140 determines the compression rate of the gaze region or a region other than the gaze region, and compresses the video. The compression efficiency determination unit 140 is an encoder that encodes the input video in accordance with the determined compression rate. The compression efficiency determination unit 140 performs encoding by a moving image encoding method such as H.264 or H.265, for example. In addition, the compression efficiency determination unit 140 encodes the input video to obtain the bit rate assigned from the compression bit rate control function 401 of the MEC 400.

The compression efficiency determination unit 140 is an image quality control unit that controls the image quality of the gaze region determined by the image quality change determination unit 130, and is an image quality improving unit that improves the image quality of the gaze region. The gaze region is a region determined by either the first determination unit 131 or the second determination unit 132. The compression efficiency determination unit 140 compresses each of the gaze region and the other region at a predetermined compression rate, thereby performing encoding such that the image quality of the gaze region has a predetermined quality. That is, by changing the compression rates of the gaze region and the other region, the gaze region is made higher in image quality than the other region. It can also be said that the image quality of other regions is made lower than the gaze region. For example, the image qualities of the gaze region and the other regions are controlled within a range of the bit rate assigned from the compression bit rate control function 401 of the MEC 400. Note that the image quality of the gaze region may be controlled by changing not only the compression rate but also a resolution, a frame rate, and the like of the image. Furthermore, the image quality of the gaze region may be controlled by changing an information amount of the color of the image, for example, the color, the grayscale, black and white, or the like.

The terminal communication unit 150 transmits the encoded data encoded by the compression efficiency determination unit 140 to the center server 200 via the base station 300. The terminal communication unit 150 is a transmission unit that transmits a video in which the image quality of the gaze region is controlled. In addition, the terminal communication unit 150 receives prediction information of the gaze target transmitted from the center server 200 via the base station 300. The terminal communication unit 150 is an acquisition unit that acquires prediction information obtained by predicting the position of the gaze target. The terminal communication unit 150 is an interface capable of communicating with the base station 300, and is, for example, a radio interface of 4G, local 5G/5G, LTE, a radio LAN, or the like, and may be a radio or wired interface of any other communication scheme. The terminal communication unit 150 may include a first terminal communication unit that transmits encoded data and a second terminal communication unit that receives prediction information of a gaze target. The first terminal communication unit and the second terminal communication unit may be communication units of the same communication scheme, or may be communication units of different communication schemes.

As illustrated in FIG. 6, the center server 200 includes a center communication unit 210, a decoder 220, an action recognition unit 230, an extraction information storage unit 240, a gaze target analysis unit 250, and a gaze target position prediction unit 260.

The center communication unit 210 receives encoded data transmitted from the terminal 100 via the base station 300. The center communication unit 210 is a reception unit that receives a video in which the image quality of the gaze region is controlled. In addition, the center communication unit 210 transmits prediction information of the gaze target predicted by the gaze target position prediction unit 260 to the terminal 100 via the base station 300. The center communication unit 210 is a notification unit that performs notification of the prediction information obtained by predicting the position of the gaze target. The center communication unit 210 is an interface capable of communicating with the Internet or a core network, and is, for example, a wired interface for IP communication, and may be a wired or radio interface of any other communication scheme. The center communication unit 210 may include a first center communication unit that receives encoded data and a second center communication unit that transmits prediction information of a gaze target. The first center communication unit and the second center communication unit may be communication units of the same communication scheme, or may be communication units of different communication schemes.

The decoder 220 decodes (decodes) the encoded data received from the terminal 100. The decoder 220 supports the encoding method of the terminal 100, and performs decoding by a moving image encoding method such as H.264 or H.265, for example. The decoder 220 performs decoding in accordance with the compression rate of each region to generate a decoded video (also referred to as a reception video).

The action recognition unit 230 recognizes an action of an object in the decoded reception video. The action recognition unit 230 performs action recognition processing of recognizing an action of the gaze target on the video in which the image quality of the gaze region is controlled. The action recognition unit 230 detects an object from the reception video, and recognizes an action of the detected object. The action recognition unit 230 recognizes an action of a person who is a target of action recognition, and gives a label of the recognized action, that is, an action label. The action label is a class of action and indicates a type of action.

For example, the action recognition unit 230 recognizes the action of a person based on the person and a work object detected from the reception video. The action recognition unit 230 may recognize the action of the person by specifying the relevance between the person and the work object. The relevance between the person and the work object includes which object the person is using or whether the person is not using the object. For example, a work object may be specified for each person from a distance between the person and the work object, and an action may be recognized from the specified work object. The work object related to the person and the work may be associated with each other, and the action of the person may be recognized on a rule basis, or the work object related to the person and the work may be machine-learned, and the action of the person may be recognized on a machine learning basis.

The extraction information storage unit 240 stores the extraction information extracted by action recognition processing of the action recognition unit 230. The extraction information includes an action recognition result, detection information of a person, detection information of a work object related to an action, and the like. The action recognition result includes a label of the recognized action, a score of the action label, identification information of a person who performs the recognized action, identification information of a work object used in the recognized action, and the like. The detection information of the person includes position information of a rectangular region of the person, tracking information, and the like. The tracking information is trajectory information indicating a tracking result of an object. The detection information of the work object includes an object label, a score of the object label, position information of a rectangular region of the object, tracking information, and the like. For example, an action predictor (action recognition engine) of the action recognition unit 230 performs learning such that an object involved in an action is weighted, thereby extracting candidates for a work object, which may be related, for each image, and outputting information of the extracted candidates for the work object. For example, in a case where piling work is recognized, information of a hammer which is an object related to the action is output.

The gaze target analysis unit 250 determines a gaze target based on the extraction information extracted by the action recognition processing of the action recognition unit 230. The extraction information may be acquired from the action recognition unit 230 or may be acquired from the extraction information storage unit 240. The gaze target analysis unit 250 determines a gaze target for securing image quality in order to prevent an action recognition error, based on the extracted information. For example, the gaze target analysis unit 250 determines a gaze target based on an action recognition result. The gaze target analysis unit 250 sets, as the gaze target, a person having an action that is recognized by the action recognition unit 230, that is, a person having an action that is included in the action recognition result. In a case where an action is recognized from a person and a related work object, the person and the work object may be set as gaze targets. There may be a plurality of work objects related to a person, and the person and the plurality of work objects may be set as gaze targets. For example, in a case where the piling work is recognized, an object related to the work may be set as “pile” and “hammer”, and a person, “pile”, and “hammer” may be set as gaze targets.

The gaze target position prediction unit 260 predicts the position of the gaze target in the next video. The next video is a video subsequent to the video on which the action recognition processing has been performed, and is a video (input video) acquired next by the terminal 100. The next video is a video after a predetermined time has elapsed from the video in which the action is recognized. A timing of the next video, that is, a prediction timing is, for example, after the time from when the video recognized by the terminal 100 is transmitted until the prediction information is fed back from the center server 200 to the terminal 100 has elapsed. The prediction timing of the next video may be determined in consideration of the transmission time between the terminal 100 and the center server 200. For example, the transmission time between the terminal 100 and the center server 200 may be measured or acquired to determine the prediction timing of the next video.

The gaze target position prediction unit 260 predicts the position of the gaze target to be secured in the next image quality, based on the extraction information extracted by the action recognition processing of the action recognition unit 230. The gaze target position prediction unit 260 may predict the position of the gaze target based on time-series position information of a person having the recognized action or a work object. For example, the time-series position information is trajectory information obtained from the tracking processing in the action recognition processing. The gaze target position prediction unit 260 may predict the position of the gaze target based on the action recognition result in which the action is recognized. For example, the position of the gaze target may be predicted based on a work object (use object) used by a person in the action indicated by the action recognition result. The gaze target position prediction unit 260 predicts the position of the gaze target in consideration of the time difference to the next video. The gaze target position prediction unit 260 predicts the position and the rectangular region of the gaze target by moving the gaze target on an image in accordance with the prediction timing of the next video. For example, the size and the shape of the rectangular region may be changed in accordance with the prediction timing of the next video to be predicted. The size of the rectangular region may be increased as the time until the prediction timing becomes longer. The gaze target position prediction unit 260 outputs the predicted position information of the rectangular region of the gaze target as prediction information of the gaze target. The position information is, for example, coordinates of each vertex of the rectangular region, and may be a position of the center of the rectangular region or a position of a certain point of the gaze target. The prediction information is not limited to the position information as the information regarding the predicted gaze target, and may include information extracted from the action recognition processing, such as an object label or a feature of an image of the gaze target, an action label, and a score of the action label. Furthermore, a plurality of pieces of prediction information such as information predicted from the time-series information of the recognized object or information predicted from the action recognition result may be output. Positions at a plurality of time points may be predicted, and a plurality of pieces of predicted position information may be output.

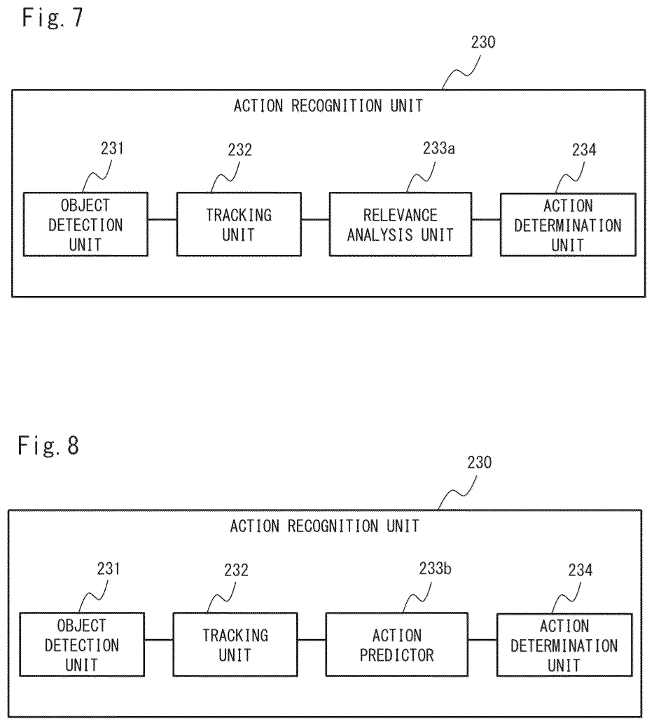

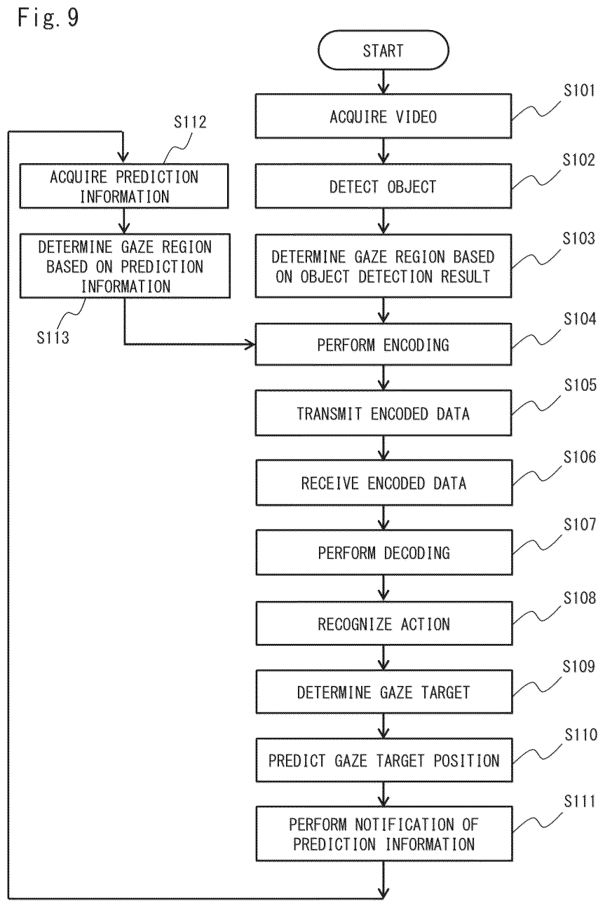

FIGS. 7 and 8 illustrate configuration examples of the action recognition unit 230 in the center server 200. FIG. 7 is a configuration example in a case where the action recognition with the relevance between the person and the work object is performed on a rule basis. In the example of FIG. 7, the action recognition unit 230 includes an object detection unit 231, a tracking unit 232, a relevance analysis unit 233a, and an action determination unit 234.

The object detection unit 231 detects an object in the input reception video. For example, similarly to the detection unit 120 of the terminal 100, the object detection unit 231 is a detection unit such as an object recognition engine using machine learning. That is, the object detection unit 231 extracts a rectangular region including an object from each image of the reception video, recognizes the object in the extracted rectangular region, and gives a label of the recognized object. The detection result of the object includes the object label and position information of the rectangular region including the object.

The tracking unit 232 tracks the detected object in the reception video. The tracking unit 232 associates the object of each image included in the reception video based on the detection result of the object. By assigning a tracking ID to the detected object, each object can be identified and tracked. For example, an object is tracked by associating objects between images by a distance or overlap (for example, intersection over union (IoU)) between a rectangular region of an object detected in a previous image and a rectangular region of an object detected in the next image.

The relevance analysis unit 233a analyzes a relevance between an object and another object for each tracked object. That is, the relevance analysis unit 233a analyzes the relevance between a person who is the action recognition target and a work object that may be used by the person in the work. For example, the label of the work object is set in advance as a label of an object related to a person. For example, the relevance between objects is the position of the object, or the distance or overlap between rectangular regions (for example, IoU). With the relevance between the person and the work object, it can be determined whether or not the person is performing the work using the work object. For example, a work object related to the person is extracted based on the distance or overlap between the person and the work object.

The action determination unit 234 determines an action of the object based on the analyzed relevance between the objects. The action determination unit 234 associates the work object with the work content in advance, and recognizes the work content of the person based on the work object related to the person extracted from the relevance between the person and the work object. The work content may be recognized based on the feature of the person including the posture and shape of the person and the related work object. For example, the feature of the person and the work object may be associated with the work content. The action determination unit 234 outputs the work content of the recognized person as an action label.

In addition, in a case where the work object related to the person is not detected, the action determination unit 234 may recognize the action of the person only from the person. For example, the posture or shape of the person and the work content may be associated in advance as the feature of the person, and the work content may be specified based on the posture or shape of the person extracted from the image.

FIG. 8 is a configuration example in a case where the action recognition with the relevance between the person and the work object is performed on the machine learning basis. In the example of FIG. 8, the action recognition unit 230 includes the object detection unit 231, the tracking unit 232, an action predictor 233b, and the action determination unit 234. In this example, the action recognition unit 230 includes the action predictor 233b instead of the relevance analysis unit 233a in FIG. 7, and other components are similar to those in FIG. 7.

The action predictor 233b predicts an action of an object for each object tracked by the tracking unit 232. The action predictor 233b recognizes the action of a person tracked in the reception video and gives a label of the recognized action. For example, the action predictor 233b recognizes the action of the person in the reception video by the action recognition engine using machine learning such as deep learning. The action of the person can be recognized by performing machine learning on the video of the person who performs the work using the work object and the action label. For example, machine learning is performed by using learning data that is a video of a person who is working using a work object, annotation information such as positions of the person and the work object and related information between the person and the object, and action information such as a work object necessary for each work. In addition, the action predictor 233b outputs the score of the recognized action label.

The action determination unit 234 determines an action of an object based on the predicted action label. The action determination unit 234 determines the action of the person based on the score of the action label predicted by the action predictor 233b. For example, the action determination unit 234 outputs an action label having the highest score, as a recognition result.

Next, an operation of the remote monitoring system according to the present example embodiment will be described. FIG. 9 illustrates an operation example of the remote monitoring system 1. For example, description will be made on the assumption that the terminal 100 executes S101 to S105 and S112 to S113, and the center server 200 executes S106 to S111, but the present example embodiment is not limited thereto, and any apparatus may execute each process.

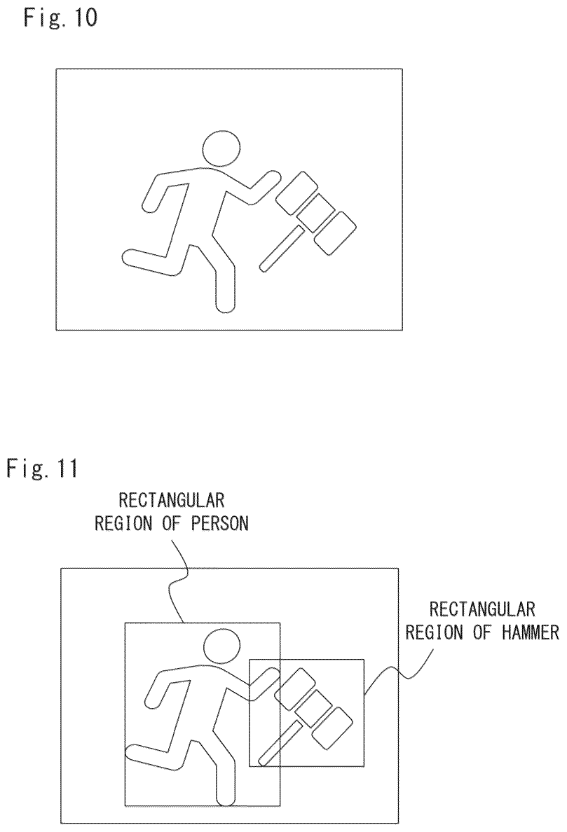

As illustrated in FIG. 9, the terminal 100 acquires a video from the camera 101 (S101). The camera 101 generates a video obtained by capturing the site, and the video acquisition unit 110 acquires a video (input video) output from the camera 101. For example, as illustrated in FIG. 10, the image of the input video includes a person who performs work in the site and a work object such as a hammer used by the person.

Subsequently, the terminal 100 detects an object based on the acquired input video (S102). The detection unit 120 detects a rectangular region in an image included in the input video using the object recognition engine, recognizes an object in the detected rectangular region, and gives a label of the recognized object. For each detected object, the detection unit 120 outputs an object label and position information of a rectangular region of the object as the object detection result. For example, when object detection is performed from the image of FIG. 10, a person and a hammer are detected, and a rectangular region of the person and a rectangular region of the hammer are detected as illustrated in FIG. 11.

Subsequently, the terminal 100 determines a gaze region in the input video based on the object detection result (S103). The first determination unit 131 of the image quality change determination unit 130 extracts an object having a label as a gaze target, based on the object detection result of each object. The first determination unit 131 extracts an object having an object label that is a person or a work object from the detected object, and determines a rectangular region of the extracted object as a gaze region. In the example of FIG. 11, a person and a hammer are detected in the image, and since the hammer corresponds to a work object, a rectangular region of the person and a rectangular region of the hammer are determined as gaze regions.

Subsequently, the terminal 100 encodes the input video based on the determined gaze region (S104). The compression efficiency determination unit 140 encodes the input video such that the gaze region has higher image quality than other regions. In the example of FIG. 11, the compression rates of the rectangular region of the person and the rectangular region of the hammer are made lower than the compression rates of the other regions, thereby improving the image quality of the rectangular region of the person and the rectangular region of the hammer.

Subsequently, the terminal 100 transmits the encoded data to the center server 200 (S105), and the center server 200 receives the encoded data (S106). The terminal communication unit 150 transmits encoded data obtained by improving the image quality of the gaze region to the base station 300. The base station 300 transfers the received encoded data to the center server 200 via the core network or the Internet. The center communication unit 210 receives the transferred encoded data from the base station 300.

Subsequently, the center server 200 decodes the received encoded data (S107). The decoder 220 decodes the encoded data in accordance with the compression rate of each region, and generates a video (reception video) in which the gaze region is improved in image quality.

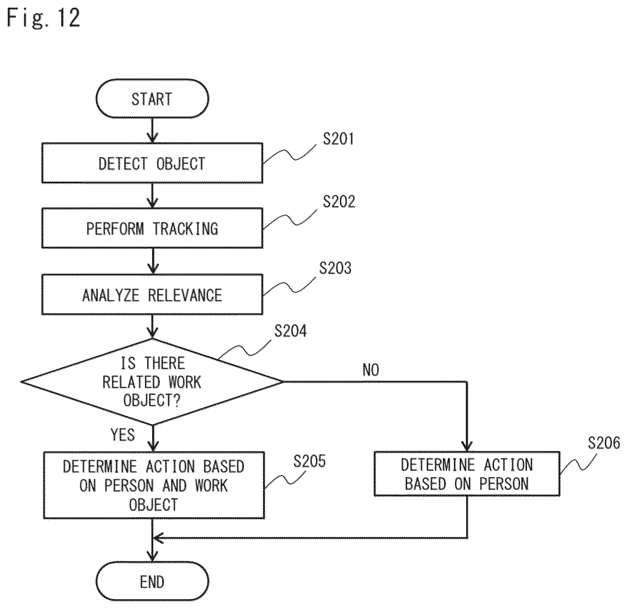

Subsequently, the center server 200 recognizes an action of an object based on the decoded reception video (S108). FIG. 12 illustrates an example of action recognition processing by the action recognition unit 230 illustrated in FIG. 7. In the example of FIG. 12, first, the object detection unit 231 detects an object in the input reception video (S201). The object detection unit 231 detects a rectangular region in each image included in the reception video using the object recognition engine, recognizes an object in the detected rectangular region, and gives a label of the recognized object. For each detected object, the object detection unit 231 outputs an object label and position information of the rectangular region of the object as the object detection result.

Subsequently, the tracking unit 232 tracks the detected object in the reception video (S202). The tracking unit 232 assigns a tracking ID to each detected object, and tracks the object identified by the tracking ID with each image.

Subsequently, the relevance analysis unit 233a analyzes the relevance between the object and another object for each tracked object (S203), and determines whether or not there is a work object related to a person (S204). The relevance analysis unit 233a extracts a person and a work object from the detection result of the tracked object, and obtains a distance between the extracted person and the work object and an overlap of rectangular regions. For example, a work object of which the distance to a person is smaller than a predetermined value or a work object of which rectangular regions overlap with each other is larger than a predetermined value is determined to be the work object related to the person.

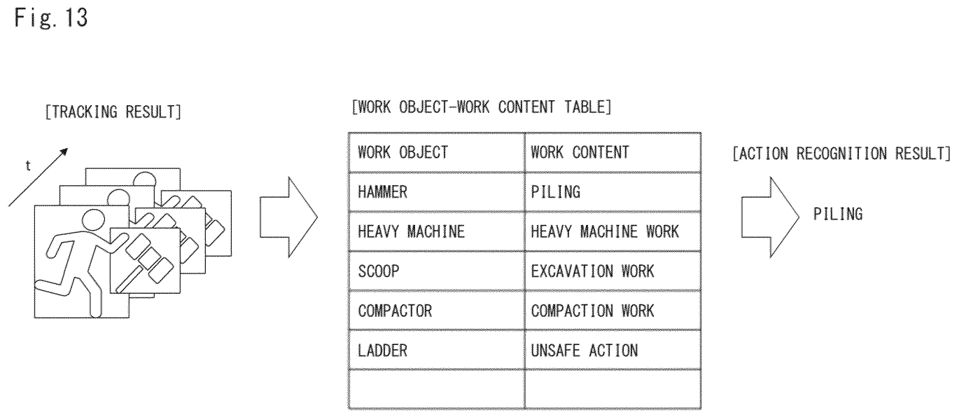

In a case where it is determined that there is the work object related to the person, the action determination unit 234 determines an action of the person based on the person and the work object (S205). The action determination unit 234 determines the action of the person based on the work object related to the detected person and the work content associated with the work object in advance. In the example of FIG. 13, a person and a hammer related to the person are detected by tracking. In addition, in a work object-work content table, the work object and the work content are stored in advance in association with each other. The work object-work content table is stored in a storage unit or the like of the center server 200. The action determination unit 234 refers to the work object-work content table from the work object related to the person, and specifies the work content associated with the work object. In this example, since piling is associated with the hammer, the action of the person is determined to be piling. The action determination unit 234 outputs the determined action. For example, the relevance (distance, overlap, or the like) between the person and the work object may be output as the score of the action.

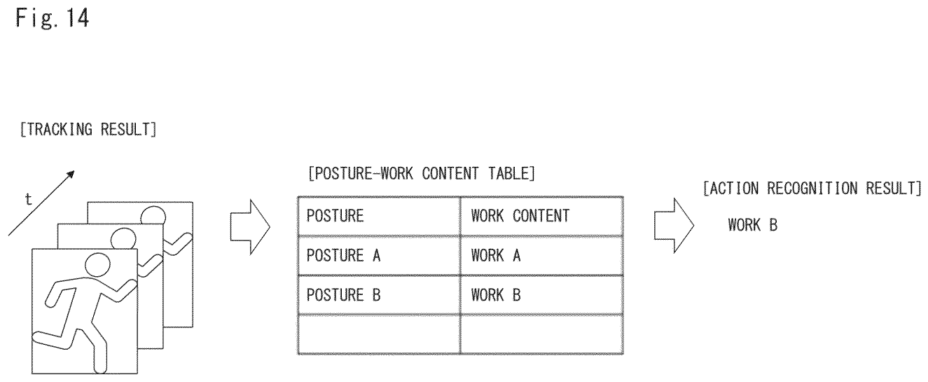

In addition, in a case where it is determined that there is no work object related to the person, the action determination unit 234 determines the action of the person based on the person (S206). The action determination unit 234 determines the action of the person based on the detected features such as the posture and shape of the person and the work content associated with the features of the person in advance. In the example of FIG. 14, only a person is detected by tracking. In addition, in a posture-work content table, the posture of the person and the work content are stored in advance in association with each other. The posture-work content table is stored in the storage unit or the like of the center server 200. For example, the posture of the person can be estimated based on a skeleton or the like extracted from the image of the person by using a posture estimation engine. The action determination unit 234 estimates the posture of the person from the image of the detected person, and refers to the posture-work content table to specify the work content associated with the estimated posture. In this example, in a case where the estimated posture of the person is the posture B, the work B is associated with the posture B, and thus the action of the person is determined to be the work B. The action determination unit 234 outputs the determined action. For example, the estimated score of the posture of the person may be output as the score of the action.

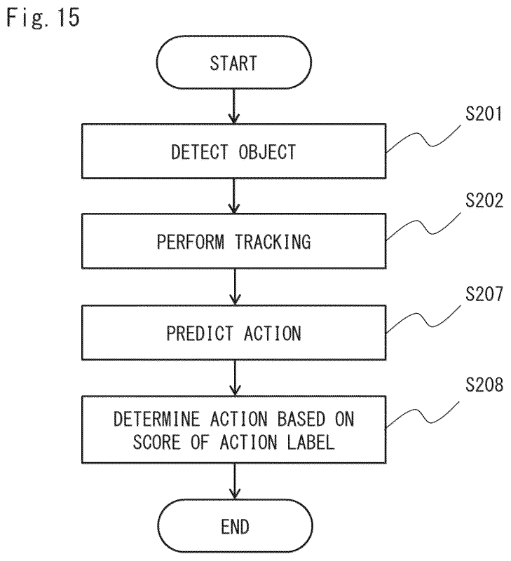

Furthermore, FIG. 15 illustrates an example of action recognition processing by the action recognition unit 230 illustrated in FIG. 8. In the example of FIG. 15, similarly to FIG. 12, the object detection unit 231 detects an object in the reception video (S201), and the tracking unit 232 tracks the object in the detected reception video (S202).

Subsequently, the action predictor 233b predicts an action of an object for each tracked object (S207). The action predictor 233b predicts an action of a person from a video including the tracked person and a work object by using the action recognition engine. The action predictor 233b outputs a label of the predicted action and a score of each action label.

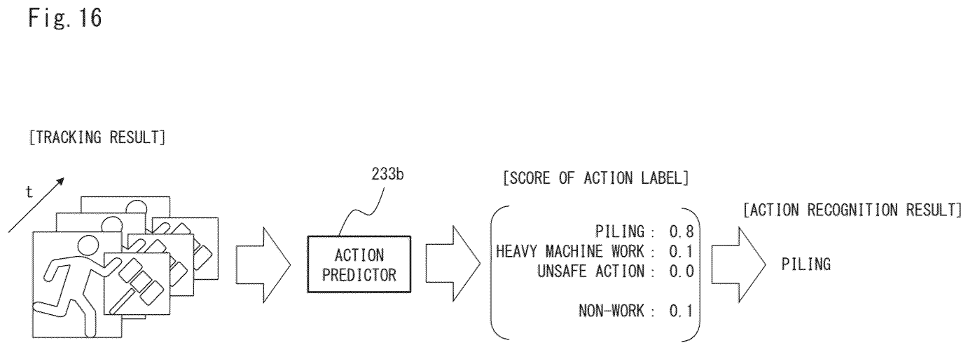

Subsequently, the action determination unit 234 determines the action of the object based on the score of the predicted action label (S208). In the example of FIG. 16, a person and a hammer are detected by tracking. The action predictor 233b recognizes the action of the person based on the video of the detected person and hammer, and outputs the score of each action label. For example, the score of piling is 0.8, the score of heavy machine work is 0.1, the score of an unsafe action is 0.0, and the score of non-work is 0.1. Then, the action determination unit 234 determines that the action of the person is piling because the score of piling is the highest. The action determination unit 234 outputs the determined action and the score of the action.

Returning to FIG. 9, following the action recognition processing, the center server 200 determines a gaze target based on the extraction information extracted by the action recognition processing (S109). The gaze target analysis unit 250 sets a person having the recognized action as the gaze target, and further includes a work object as the gaze target in a case where the recognition target includes the work object. For example, in the examples of FIGS. 13 and 16, since work of piling is recognized from a person and a hammer, the person who have recognized the work and the hammer are set as the gaze targets. In the example of FIG. 14, since the work B is recognized only from the person, only the person who has recognized the work is set as the gaze target.

Subsequently, the center server 200 predicts the position of the gaze target in the next video based on the extraction information extracted by the action recognition processing (S110). The gaze target position prediction unit 260 predicts the position (movement region) of the next gaze target by using the time-series information extracted at the time of action recognition and the action recognition result, and outputs the predicted position information of the rectangular region of the gaze target as prediction information of the gaze target.

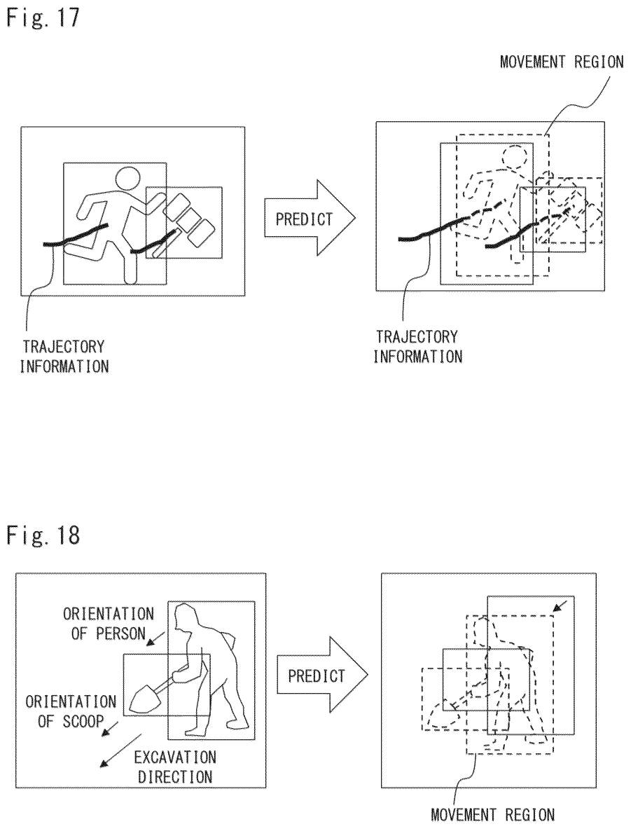

For example, in a case where the time-series information is used, the gaze target position prediction unit 260 predicts a movement region to be the next position of the person or the work object from the trajectory information obtained by tracking the person or the work object. The trajectory information is acquired from the tracking unit 232, and may be acquired using a kalman filter, a particle filter, or the like. In the example of FIG. 17, trajectory information of the person and the hammer is extracted from the video in which the action is recognized. The gaze target position prediction unit 260 predicts a movement region based on an extended line obtained by extending the trajectory information. That is, a destination obtained by extending the trajectory information is set as the movement region. The gaze target position prediction unit 260 extends the trajectory information of the person or the hammer on the image in accordance with the prediction timing of the next video, and predicts the position of the next movement region (rectangular region) of the person or the hammer.

Furthermore, in a case of using the action recognition result, the gaze target position prediction unit 260 determines the position (movement region) of the next gaze target on a rule basis for each action label. The movement region may be predicted based on the orientation of the work object or the person. For example, in a case where excavation work is recognized, a destination of a scoop or a bucket may be set as the movement region. In the example of FIG. 18, the action of the person is recognized as excavation work, and the information of the person and the scoop is extracted. For example, the gaze target position prediction unit 260 recognizes the shape of the scoop, sets the direction of a tip portion of the scoop as an orientation of the scoop, and extracts the orientation of the scoop as an excavation direction (working direction). The gaze target position prediction unit 260 moves the scoop or the person in the excavation direction on the image in accordance with the prediction timing of the next video, and predicts the position of the next movement region (rectangular region) of the scoop or the person.

Note that not only the scoop but also the position of the scoop or the person may be predicted by using the orientation of the person. For example, the orientation (forward direction) of the person can be estimated from the skeleton, the posture, and the like extracted from the image of the person. The scoop or the movement region of the person may be predicted using the orientation of the person as the excavation direction. In addition, the orientation of the scoop and the orientation of the person may be combined to extract the excavation direction.

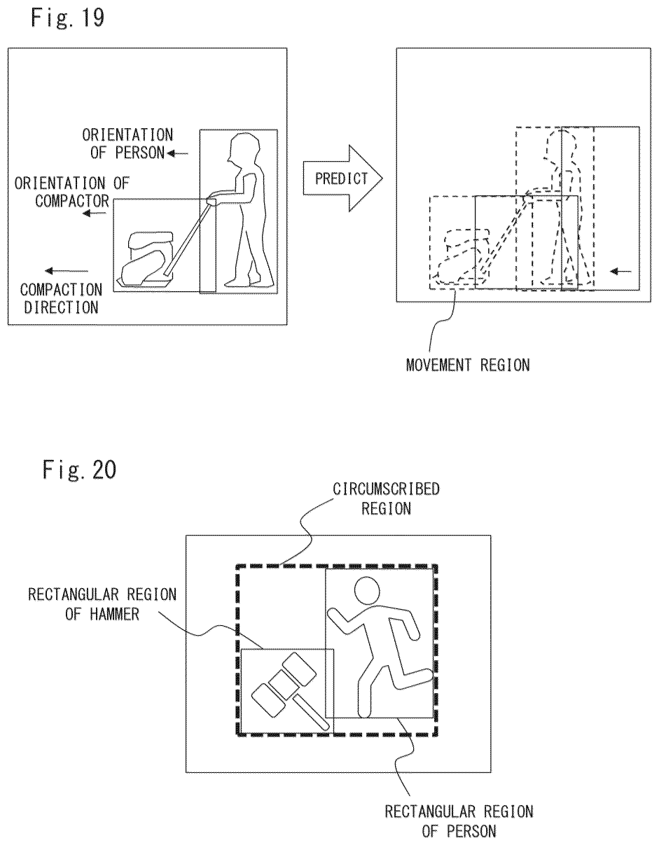

In addition, for example, in a case where compaction work is recognized, a destination to which a compactor advances may be set as the movement region. In the example of FIG. 19, the action of the person is recognized as the compaction work, and the information of the person and the compactor is extracted. For example, the gaze target position prediction unit 260 recognizes the shape of the compactor, sets the forward direction of the compactor as the orientation of the compactor, and extracts the orientation of the compactor as a compaction direction (working direction). The gaze target position prediction unit 260 moves the compactor or the person in the compaction direction on the image in accordance with the prediction timing of the next video, and predicts the position of the next movement region (rectangular region) of the compactor or the person. Similarly to FIG. 18, the orientation of the person may be set as the compaction direction, or the compaction direction may be extracted by combining the orientation of the compactor and the orientation of the person.

Subsequently, the center server 200 notifies the terminal 100 of the prediction information of the predicted gaze target (S111), and the terminal 100 acquires the prediction information of the gaze target (S112). The center communication unit 210 transmits prediction information indicating the predicted position and region of the gaze target to the base station 300 via the Internet or the core network. The base station 300 transfers the received prediction information of the gaze target to the terminal 100. The terminal communication unit 150 receives the transferred position information of the gaze target from the base station 300.

Subsequently, the terminal 100 determines the gaze region based on the received prediction information of the gaze target (S113). The second determination unit 132 of the image quality change determination unit 130 determines a region indicated by the prediction information of the gaze target notified from the center server 200 as the gaze region. In the example of FIG. 20, the prediction information indicates a rectangular region of a person and a rectangular region of a hammer, and these regions are determined as the gaze regions. In addition, a circumscribed region including the rectangular region of the person and the rectangular region of the hammer may be set as the gaze region. The circumscribed region may be notified from the center server 200 to the terminal 100. Thereafter, S104 to S113 are repeated.

As described above, in the present example embodiment, in the system that recognizes the action of the object from the video, the position of the target object in the next video is predicted based on the time-series information of the target object, the action recognition result, and the like, and the image quality of the predicted region is improved and sharpened. As a result, the image quality of a specific portion including the target object can be secured in accordance with the movement of a target object, the region other than the region related to the action recognition can be compressed, and the action recognition mistake can be prevented while the data transmission amount is suppressed.

### Second Example Embodiment

Hereinafter, a second example embodiment will be described with reference to the drawings. First, a configuration of a remote monitoring system according to the present example embodiment will be described. In the present example embodiment, only the configuration of the terminal is different from that in the first example embodiment, and thus, a configuration example of the terminal will be described here. Note that the present example embodiment can be implemented in combination with the first example embodiment, and each component described in the first example embodiment may be appropriately used.

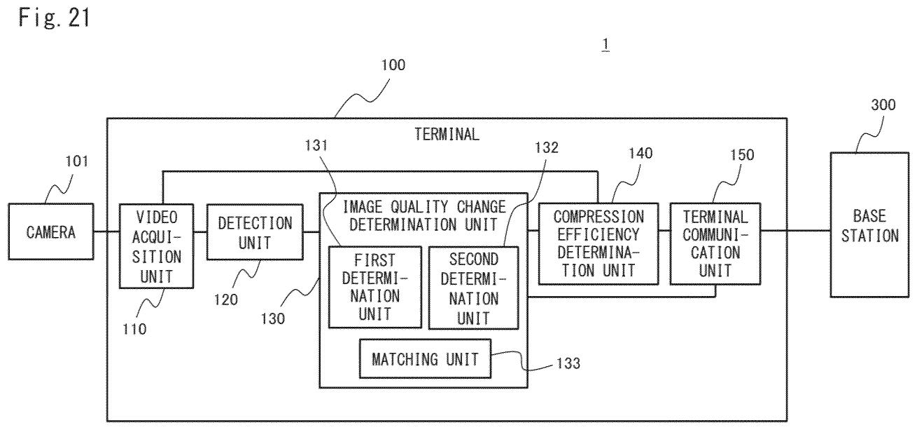

FIG. 21 illustrates the configuration example of a terminal 100 according to the present example embodiment. As illustrated in FIG. 21, in the present example embodiment, a matching unit 133 is added to an image quality change determination unit 130 of the terminal 100. Other components are similar to those in the first example embodiment.

The matching unit 133 performs matching between the prediction information of the gaze target notified from the center server 200 and the detection result of the object detected from the input video by the detection unit 120. That is, matching between the gaze target predicted by the center server 200 and the object detected by the terminal 100 is performed. The input video in which the object for performing matching has been detected is a video subsequent to the video in which the center server 200 has performed the action recognition, that is, a video corresponding to the prediction information of the gaze target predicted by the center server 200. In the matching, the prediction information of the gaze target is compared with the detection result of the object, and it is determined whether or not the predicted object and the detected object are the same, that is, whether or not the matching is performed. The matching unit 133 performs matching based on, for example, the type of the object, the feature of the image of the object, the position information of the object, and the like.

A second determination unit 132 determines the gaze region of the input video based on the matching result of the matching unit 133. The second determination unit 132 may determine the gaze region based on the detection result of the object or the prediction information of the gaze target, or may determine whether or not to determine the gaze region, in accordance with whether or not matching between the prediction information of the gaze target and the detection result of the object is performed.

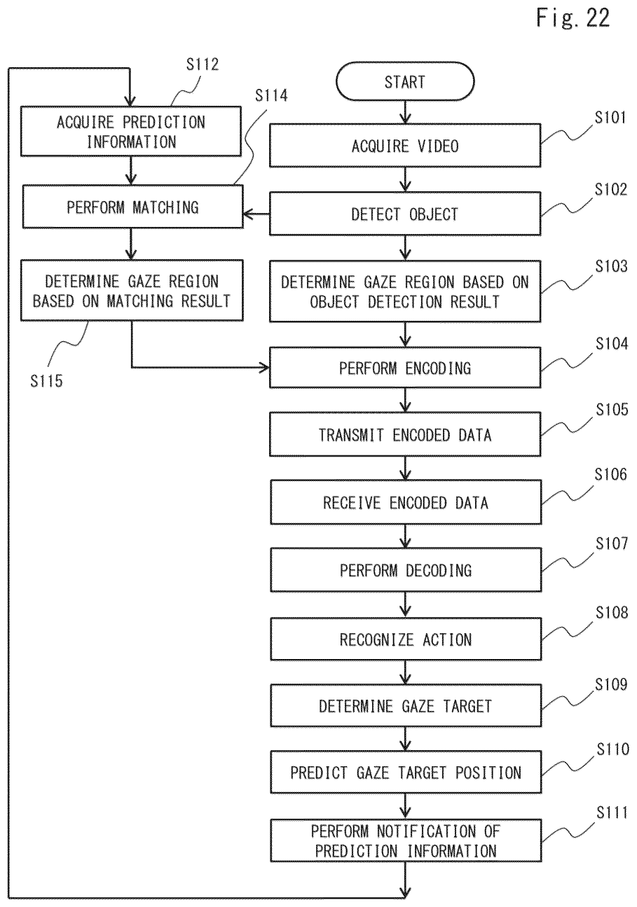

Next, an operation of the remote monitoring system according to the present example embodiment will be described. FIG. 22 illustrates a configuration example of the remote monitoring system according to the present example embodiment. S101 to S111 in FIG. 22 are the same as those in the first example embodiment.

As illustrated in FIG. 22, when acquiring prediction information of a gaze target from the center server 200 (S112), the terminal 100 performs matching (S114). The detection unit 120 detects the object from the video input after the video in which the center server 200 has performed the action recognition, and the matching unit 133 performs matching between the prediction information of the gaze target acquired from the center server 200 and the detection result of the object detected from the input video by the detection unit 120.

In the present example embodiment, the prediction information of the gaze target predicted and notified by the center server 200 and the detection result of the object detected by the detection unit 120 include feature information such as the type that is the object label, the position information of the rectangular region, and the feature amount of the image of the object included in the rectangular region.

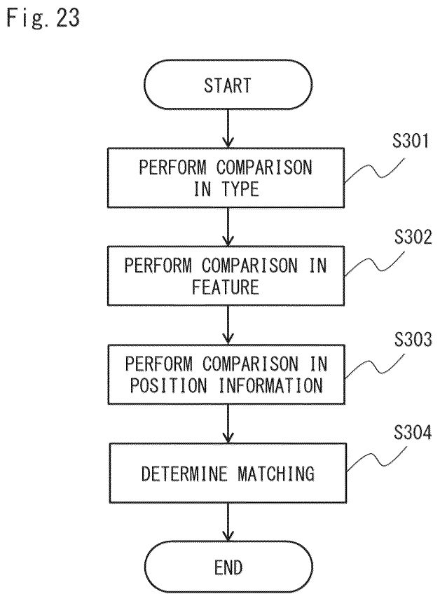

FIG. 23 illustrates an example of the matching processing. In this example, the matching is determined by comparing the type of the object, the feature of the image of the object, and the position information of the object, but the matching may be determined by comparing any of the type of the object, the feature of the image of the object, and the position information of the object.

As illustrated in FIG. 23, the matching unit 133 compares the type of the object in the prediction information of the gaze target with the type of the object in the detection result of the object (S301). The matching unit 133 determines whether or not the type of the object included in the prediction information coincides with the type of the object included in the detection result. In a case where the types of the objects are the same or similar, the matching unit 133 determines that the objects coincide with each other. The type of similar objects is a type of objects belonging to the same category, a higher category, or a lower category, and may be set in advance. For example, since a dump car and a truck are similar to each other, it may be determined that the dump car and the truck coincide with each other.

Further, the matching unit 133 compares the feature of the image of the object in the prediction information of the gaze target with the feature of the image of the object in the detection result of the object (S302). The matching unit 133 determines whether or not the feature of the image in the region of the object included in the prediction information coincides with the feature of the image in the region of the object included in the detection result. For example, image feature amounts such as histograms of oriented gradients (HOG) and intermediate layer features of deep learning, and color features such as color histograms are compared. The matching unit 133 determines whether or not there is a coincidence based on the similarity of the features of the images. For example, coincidence may be determined in a case where the similarity is larger than a predetermined threshold value.

Further, the matching unit 133 compares the position information of the object in the prediction information of the gaze target with the position information of the object in the detection result of the object (S303). The comparison of the position information includes comparison of the position of the region and comparison of the size of the region. The matching unit 133 determines whether or not the pieces of position information coincide with each other, based on the distance between the object included in the prediction information and the object included in the detection result, the overlap between the rectangular region of the object included in the prediction information and the rectangular region of the object included in the detection result, and a difference between the size of the rectangular region of the object included in the prediction information and the size of the rectangular region of the object included in the detection result. The distance between the rectangular regions may be a distance between the centers of the rectangular regions, or may be a distance between any points included in the rectangular region. The overlap of the rectangular regions is, for example, IoU. For the size of the rectangular region, a difference only in size may be obtained regardless of the position. For example, in a case where the distance between the rectangular regions is smaller than a predetermined threshold value, in a case where the overlap between the rectangular regions is larger than a predetermined threshold value, or in a case where the difference in size between the rectangular regions is smaller than a predetermined threshold value, the matching unit 133 determines that the pieces of the position information coincide with each other.

Subsequently, the matching unit 133 determines whether or not to perform matching based on these determination results (S304). For example, in a case where all the comparison conditions of the type of the object, the feature of the image of the object, and the position information coincide, it may be determined that the prediction information of the gaze target and the detection result of the object match with each other. In addition, matching may be determined in a case where any comparison condition among the type of the object, the feature of the image of the object, and the position information coincides, or in a case where a plurality of freely selected comparison conditions coincide. For example, the matching may be determined in a case where the type of the object and the feature of the image of the object coincide, in a case where the type of the object and the position information coincide, in a case where the feature and the position information of the image of the object coincide, or the like.

Subsequently, the terminal 100 determines the gaze region based on the matching result (S115). For example, in a case where matching between the prediction information of the gaze target and the detection result of the object is performed, the second determination unit 132 determines the gaze region based on the detection result of the object. That is, the region indicated by the detection result of the object is set as the gaze region. In addition, in a case where the prediction information of the gaze target does not coincide with the detection result of the object, the gaze region may be determined based on the prediction information of the gaze target, or the gaze region may not be determined. In a case where the gaze region is determined based on the prediction information of the gaze target, the region indicated by the prediction information of the gaze target is set as the gaze region. In a case where the gaze region is not determined, it is not necessary to improve the image quality at the time of encoding. For example, the score of the action recognition result may be acquired from the center server 200, and in a case where the prediction information of the gaze target and the detection result of the object do not match, it may be determined whether or not to determine the gaze region based on the score of the action recognition result. In a case where the score is smaller than a predetermined value, the gaze region may be determined based on the prediction information. In a case where the score is larger than the predetermined value, the gaze region does not need to be determined. Furthermore, in a case where it is not possible to obtain the detection result of the object, it may be determined whether or not to determine the gaze region based on the score of the action recognition result.

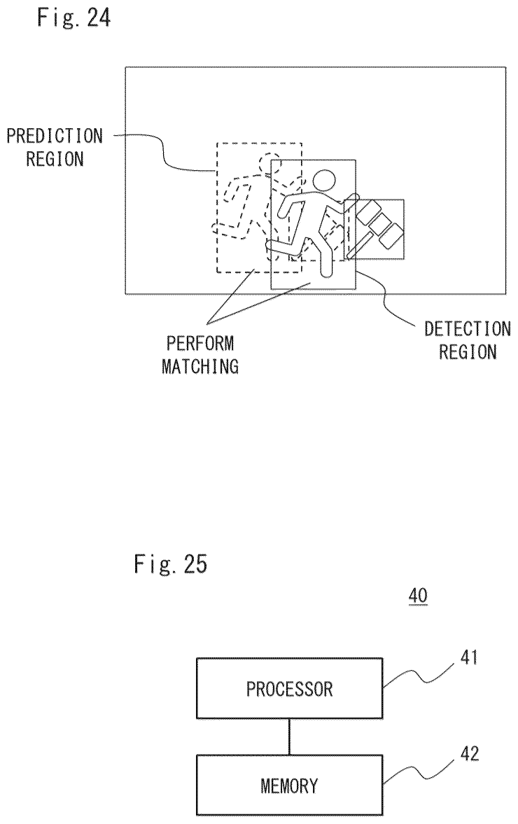

In the example of FIG. 24, the prediction information of the gaze target includes the rectangular regions of the person and the hammer, and the detection result of the object includes the rectangular regions of the person and the hammer. In this example, since the rectangular regions of the person overlap each other and the rectangular regions of the hammer overlap each other, it is determined that the prediction information of the gaze target including the person and the work object matches the detection result of the object. In this case, the region of the detection result of the object including the person and the work object is set as the gaze region. In a case where the prediction information of the gaze target includes a person and a work object, matching is determined for each of the person and the work object. In a case where both the person and the work object match, a region including the person and the work object may be set as the gaze region. At least in a case where the persons match each other, a region including the person and the work object may be set as the gaze region.

Furthermore, in a case where prediction information for a plurality of gaze targets is acquired, matching between the prediction information for the plurality of gaze targets and a detection result of an object is determined, any region is selected in accordance with the matching result, and the gaze region is determined based on the selected region. For example, in a case where the detection result of the object matches any prediction information of the gaze target, the gaze region may be determined based on the matched detection result of the object. In a case where the detection result of the object is not matched with the prediction information of any gaze target, the gaze region may be determined based on the prediction information of the gaze target closest to the detection result of the object.

In addition, in a case where the detection results of the plurality of objects are acquired, matching between the prediction information of the gaze target and the detection results of the plurality of objects is determined, any region is selected in accordance with the matching result, and the gaze region is determined based on the selected region. For example, in a case where the detection result of any object matches the prediction information of the gaze target, the gaze region may be determined based on the matched detection result of the object. In a case where the detection results of the plurality of objects match, the gaze region may be determined based on the detection result of the object closest to the prediction information of the gaze target. In a case where the detection result of any object is not matched with the prediction information of the gaze target, the gaze region may be determined based on the prediction information of the gaze target, or the gaze region may be determined based on the detection result of the object closest to the prediction information of the gaze target.

As described above, in the present example embodiment, in the configuration of the first example embodiment, matching between information predicted from the action recognition result or the like and information detected from an actually acquired video is further performed, and a region to be improved in image quality and sharpened is determined based on the matching result. As a result, it is possible to secure the image quality of the region matching the predicted target object in the actually acquired video, and thus, it is possible to reliably prevent the action recognition mistake.

Note that the present disclosure is not limited to the above-described example embodiments, and can be appropriately modified without departing from the scope. For example, in the second example embodiment, the information predicted by the center server and the information detected by the terminal are matched, but the information obtained from the action recognition and the information detected by the terminal may be matched without performing prediction by the center server. That is, the extraction information extracted from the center server by the action recognition processing such as the action recognition result may be fed back to the terminal. In addition, the processing flow described in the above example embodiments is an example, and the order of each processing is not limited to the above example. The order of some processes may be changed and executed, or some processes may be executed in parallel.

Each configuration in the above-described example embodiments may be implemented by hardware, software, or both, and may be implemented by one piece of hardware or software or by a plurality of pieces of hardware or software. Each apparatus and each function (process) may be realized by a computer 40 including a processor 41, such as a central processing unit (CPU), and a memory 42, which is a storage apparatus, as illustrated in FIG. 25. For example, programs for performing the methods (video processing method) in the example embodiments may be stored in the memory 42 and the functions may be realized by the processor 41 executing the programs stored in the memory 42.

These programs include a group of instructions (or software codes) causing a computer to perform one or more of the functions described in the example embodiments when read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage apparatus. The program may be transmitted on a transitory computer-readable medium or a communication medium. As an example and not by way of limitation, the transitory computer-readable medium or the communication medium includes propagated signals in electrical, optical, acoustic, or any other form.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A video processing system including:
image quality control means for controlling an image quality of a gaze region including a gaze target in an input video;
recognition means for performing recognition processing of recognizing the gaze target on the video in which the image quality of the gaze region is controlled;
prediction means for predicting a position of the gaze target in a video subsequent to the video on which the recognition processing has been performed, based on extraction information extracted from the recognition processing; and
determination means for determining the gaze region for which the image quality control means controls an image quality in the subsequent video, based on the predicted position of the gaze target.

### Supplementary Note 2

The video processing system according to Supplementary Note 1, in which the extraction information includes time-series position information of the gaze target.

### Supplementary Note 3

The video processing system according to Supplementary Note 2, in which the time-series position information of the gaze target includes trajectory information of the gaze target obtained from tracking processing in the recognition processing.

### Supplementary Note 4

The video processing system according to Supplementary Note 3, in which the prediction means predicts the position of the gaze target based on an extended line obtained by extending the trajectory information.

### Supplementary Note 5

The video processing system according to any one of Supplementary Notes 1 to 4, in which the extraction information includes an action recognition result for the gaze target.

### Supplementary Note 6

The video processing system according to Supplementary Note 5, in which the prediction means predicts the position of the gaze target based on a use object that is an object used in an action indicated by the action recognition result.

### Supplementary Note 7

The video processing system according to Supplementary Note 6, in which the prediction means predicts the position of the gaze target based on an orientation of the use object.

### Supplementary Note 8

The video processing system according to any of Supplementary Notes 5 to 7, in which the prediction means predicts the position of the gaze target based on an orientation of a person who performs an action indicated by the action recognition result.

### Supplementary Note 9

The video processing system according to any one of Supplementary Notes 1 to 8, further including detection means for detecting an object from a video input after the video on which the recognition processing has been performed,
in which the determination means determines the gaze region based on a matching result between the gaze target having the predicted position and the detected object.

### Supplementary Note 10

The video processing system according to Supplementary Note 9, in which the determination means performs matching based on a type of an object, a feature of an image, or position information in the gaze target having the predicted position and the detected object.

### Supplementary Note 11

The video processing system according to Supplementary Note 10, in which, in a case where the type of the gaze target having the predicted position and the type of the detected object are the same or similar, the determination means determines that the gaze target having the predicted position and the detected object match each other.

### Supplementary Note 12

The video processing system according to Supplementary Note 10, in which, in a case where a similarity between a feature of an image including the gaze target having the predicted position and a feature of an image including the detected object is larger than a predetermined value, the determination means determines that the gaze target having the predicted position and the detected object match each other.

### Supplementary Note 13

The video processing system according to Supplementary Note 10, in which, in a case where a distance between the gaze target having the predicted position and the detected object is smaller than a predetermined value, in a case where an overlap between a region of the gaze target having the predicted position and a region of the detected object is larger than a predetermined value, or in a case where a difference between a size of the region of the gaze target having the predicted position and a size of the region of the detected object is smaller than a predetermined value, the determination means determines that the gaze target having the predicted position and the detected object match each other.

### Supplementary Note 14

The video processing system according to any one of Supplementary Notes 9 to 13, in which, in a case where it is determined that the gaze target having the predicted position and the detected object match each other, the determination means determines the gaze region based on the detected object.

### Supplementary Note 15

The video processing system according to any one of Supplementary Notes 9 to 14, in which, in a case where it is determined that the gaze target having the predicted position and the detected object do not match, the determination means determines the gaze region or does not determine the gaze region based on the gaze target having the predicted position.

### Supplementary Note 16

The video processing system according to any one of Supplementary Notes 9 to 15, in which the determination means selects any region between a plurality of the gaze targets having the predicted positions and the detected object in accordance with a matching result between the plurality of gaze targets having the predicted positions and the detected object, and determines the gaze region based on the selected region.

### Supplementary Note 17

The video processing system according to any one of Supplementary Notes 9 to 16, in which the determination means selects any region between the gaze target having the predicted position and a plurality of the detected objects in accordance with a matching result between the gaze target having the predicted position and the plurality of detected objects, and determines the gaze region based on the selected region.

### Supplementary Note 18

The video processing system according to any one of Supplementary Notes 1 to 17, in which the determination means determines whether or not to determine the gaze region based on a recognition result in the recognition processing.

### Supplementary Note 19

The video processing system according to Supplementary Note 18, in which, in a case where a score of the recognition result is smaller than a predetermined value, the determination means determines the gaze region.

### Supplementary Note 20

The video processing system according to any one of Supplementary Notes 1 to 18, in which
the gaze target includes a person who is a target of the recognition processing and a use object used by the person, and
the gaze region includes a region of the person and a region of the use object.

### Supplementary Note 21

The video processing system according to any one of Supplementary Notes 1 to 20, in which the image quality control means makes the image quality of the gaze region higher than other regions.

### Supplementary Note 22

A video processing method including:
controlling an image quality of a gaze region including a gaze target in an input video:
performing recognition processing of recognizing the gaze target on a video in which the image quality of the gaze region is controlled;
predicting a position of the gaze target in a video subsequent to the video on which the recognition processing has been performed, based on extraction information extracted from the recognition processing; and
determining the gaze region for which an image quality is controlled in the subsequent video, based on the predicted position of the gaze target.

### Supplementary Note 23

The video processing method according to Supplementary Note 22, in which the extraction information includes time-series position information of the gaze target.

### Supplementary Note 24

The video processing method according to Supplementary Note 22 or 23, in which the extraction information includes an action recognition result for the gaze target.

### Supplementary Note 25

The video processing method according to Supplementary Note 24, in which the position of the gaze target is predicted based on a use object that is an object used in an action indicated by the action recognition result.

### Supplementary Note 26

The video processing method according to Supplementary Note 24 or 25, in which the position of the gaze target is predicted based on an orientation of a person who performs an action indicated by the action recognition result.

### Supplementary Note 27

The video processing method according to any one of Supplementary Notes 22 to 26, further including:
detecting an object from a video input after the video on which the recognition processing has been performed; and
determining the gaze region based on a matching result between the gaze target having the predicted position and the detected object.

### Supplementary Note 28

The video processing method according to any one of Supplementary Notes 22 to 27, in which
the gaze target includes a person who is a target of the recognition processing and a use object used by the person, and
the gaze region includes a region of the person and a region of the use object.

### Supplementary Note 29

A video processing apparatus including:
image quality control means for controlling an image quality of a gaze region including a gaze target in an input video;
recognition means for performing recognition processing of recognizing the gaze target on the video in which the image quality of the gaze region is controlled;
prediction means for predicting a position of the gaze target in a video subsequent to the video on which the recognition processing has been performed, based on extraction information extracted from the recognition processing; and
determination means for determining the gaze region for which the image quality control means controls an image quality in the subsequent video, based on the predicted position of the gaze target.

### Supplementary Note 30

The video processing apparatus according to Supplementary Note 29, in which the extraction information includes time-series position information of the gaze target.

### Supplementary Note 31

The video processing apparatus according to Supplementary Note 29 or 30, in which the extraction information includes an action recognition result for the gaze target.

### Supplementary Note 32

The video processing apparatus according to Supplementary Note 31, in which the prediction means predicts the position of the gaze target based on a use object that is an object used in an action indicated by the action recognition result.

### Supplementary Note 33

The video processing apparatus according to Supplementary Note 31 or 32, in which the prediction means predicts the position of the gaze target based on an orientation of a person who performs an action indicated by the action recognition result.

### Supplementary Note 34

The video processing apparatus according to any one of Supplementary Notes 29 to 33, in which
the gaze target includes a person who is a target of the recognition processing and a use object used by the person, and
the gaze region includes a region of the person and a region of the use object.

### Supplementary Note 35

A video processing program for causing a computer to execute a process including:
controlling an image quality of a gaze region including a gaze target in an input video;
performing recognition processing of recognizing the gaze target on a video in which the image quality of the gaze region is controlled;
predicting a position of the gaze target in a video subsequent to the video on which the recognition processing has been performed, based on extraction information extracted from the recognition processing; and
determining the gaze region for which an image quality is controlled in the subsequent video, based on the predicted position of the gaze target.

### REFERENCE SIGNS LIST

1 REMOTE MONITORING SYSTEM
10 VIDEO PROCESSING SYSTEM
11 IMAGE QUALITY CONTROL UNIT
12 RECOGNITION UNIT
13 PREDICTION UNIT
14 DETERMINATION UNIT
20 VIDEO PROCESSING APPARATUS
40 COMPUTER
41 PROCESSOR
42 MEMORY
100 TERMINAL
101 CAMERA
102 COMPRESSION EFFICIENCY OPTIMIZATION FUNCTION
103 VIDEO TRANSMISSION FUNCTION
110 VIDEO ACQUISITION UNIT
120 DETECTION UNIT
130 IMAGE QUALITY CHANGE DETERMINATION UNIT
131 FIRST DETERMINATION UNIT
132 SECOND DETERMINATION UNIT
133 MATCHING UNIT
140 COMPRESSION EFFICIENCY DETERMINATION UNIT
150 TERMINAL COMMUNICATION UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 CENTER COMMUNICATION UNIT
220 DECODER
230 ACTION RECOGNITION UNIT
231 OBJECT DETECTION UNIT
232 TRACKING UNIT
233a RELEVANCE ANALYSIS UNIT
233b ACTION PREDICTOR
234 ACTION DETERMINATION UNIT
240 EXTRACTION INFORMATION STORAGE UNIT
250 GAZE TARGET ANALYSIS UNIT
260 GAZE TARGET POSITION PREDICTION UNIT
300 BASE STATION
400 MEC
40 COMPRESSION BIT RATE CONTROL FUNCTION
402 TERMINAL CONTROL FUNCTION

What is claimed is:

1. A video processing system comprising:
a memory configured to store instructions, and a processor configured to execute the instructions to;
control an image quality of a gaze region including a gaze target in an input video;
perform recognition processing of recognizing the gaze target on the video in which the image quality of the gaze region is controlled;
predict a position of the gaze target in a video subsequent to the video on which the recognition processing has been performed, based on extraction information extracted from the recognition processing; and
determine the gaze region for which the image quality control means controls an image quality in the subsequent video, based on the predicted position of the gaze target.

2. The video processing system according to claim 1, wherein the extraction information includes time-series position information of the gaze target.

3. The video processing system according to claim 1, wherein the extraction information includes an action recognition result for the gaze target.

4. The video processing system according to claim 3, wherein the processor is further configured to execute the instructions to predict the position of the gaze target based on a use object that is an object used in an action indicated by the action recognition result.

5. The video processing system according to claim 3, wherein the processor is further configured to execute the instructions to predict the position of the gaze target based on an orientation of a person who performs an action indicated by the action recognition result.

6. The video processing system according to claim 1, wherein the processor is further configured to execute the instructions to detect an object from a video input after the video on which the recognition processing has been performed, and
determine the gaze region based on a matching result between the gaze target having the predicted position and the detected object.

7. The video processing system according to claim 1, wherein
the gaze target includes a person who is a target of the recognition processing and a use object used by the person, and
the gaze region includes a region of the person and a region of the use object.

8. A video processing method comprising:
controlling an image quality of a gaze region including a gaze target in an input video;
performing recognition processing of recognizing the gaze target on a video in which the image quality of the gaze region is controlled;
predicting a position of the gaze target in a video subsequent to the video on which the recognition processing has been performed, based on extraction information extracted from the recognition processing; and
determining the gaze region for which an image quality is controlled in the subsequent video, based on the predicted position of the gaze target.

9. The video processing method according to claim 8, wherein the extraction information includes time-series position information of the gaze target.

10. The video processing method according to claim 8, wherein the extraction information includes an action recognition result for the gaze target.

11. The video processing method according to claim 10, wherein the position of the gaze target is predicted based on a use object that is an object used in an action indicated by the action recognition result.

12. The video processing method according to claim 10, wherein the position of the gaze target is predicted based on an orientation of a person who performs an action indicated by the action recognition result.

13. The video processing method according to claim 8, further comprising:
detecting an object from a video input after the video on which the recognition processing has been performed; and
determining the gaze region based on a matching result between the gaze target having the predicted position and the detected object.

14. The video processing method according to claim 8, wherein
the gaze target includes a person who is a target of the recognition processing and a use object used by the person, and
the gaze region includes a region of the person and a region of the use object.

15. A video processing apparatus comprising:
a memory configured to store instructions, and
a processor configured to execute the instructions to;
control an image quality of a gaze region including a gaze target in an input video;
perform recognition processing of recognizing the gaze target on the video in which the image quality of the gaze region is controlled;
predict a position of the gaze target in a video subsequent to the video on which the recognition processing has been performed, based on extraction information extracted from the recognition processing; and
determine the gaze region for which the image quality control means controls an image quality in the subsequent video, based on the predicted position of the gaze target.

16. The video processing apparatus according to claim 15, wherein the extraction information includes time-series position information of the gaze target.

17. The video processing apparatus according to claim 15, wherein the extraction information includes an action recognition result for the gaze target.

18. The video processing apparatus according to claim 17, wherein the processor is further configured to execute the instructions to predict the position of the gaze target based on a use object that is an object used in an action indicated by the action recognition result.

19. The video processing apparatus according to claim 17, wherein the processor is further configured to execute the instructions to predict the position of the gaze target based on an orientation of a person who performs an action indicated by the action recognition result.

20. The video processing apparatus according to claim 15, wherein
the gaze target includes a person who is a target of the recognition processing and a use object used by the person, and
the gaze region includes a region of the person and a region of the use object.
